(19) United States
(12) Patent Application Publication
(10) Pub. No.: US 2013/0061449 A1
(43) Pub. Date: Mar. 14, 2013

(54) FAUCET LEVER SAFETY LOCK

(71) Applicants: Eric Powell, Las Vegas, NV (US); April Powell, Las Vegas, NV (US)

(72) Inventors: Eric Powell, Las Vegas, NV (US); April Powell, Las Vegas, NV (US)

(21) Appl. No.: 13/229,620

(22) Filed: Sep. 9, 2011

(51) Int. Cl. E03C 1/04; B23P 11/00

(52) U.S. Cl. 29/525.01; 403/345

(57) ABSTRACT

A faucet lever safety lock prevents operation of various faucets by preventing use of the faucets' handles. The faucet lever safety lock may comprise one or more struts configured to locate one or more handle engagement devices at a faucet's handles when the faucet lever safety lock is assembled. The handle engagement devices engage to prevent their movement and operation. The faucet lever safety lock may be secured in an assembled configuration via a coupling device that ensures that the handle engagement devices maintain their relative position. The coupling device may be releasable to allow the faucet lever safety lock to be disassembled to allow operation of the faucet.

### BACKGROUND OF THE INVENTION

1. Field of the Invention

The invention relates generally to safety locks, and in particular to a faucet lever safety lock.

2. Related Art

Safety in residential and commercial facilities is important to facility owners and their occupants. For example, an owner or occupant may wish to restrict access to various hazards, items, or areas in his or her residential or commercial facility. Traditionally this has been accomplished by locking rooms or areas within the facility to prevent access to items therein or the area itself. In addition, safes and locks have traditionally been used to lock individual items, such as to prevent access to such items.

From the discussion that follows, it will become apparent that the present invention addresses the deficiencies associated with the prior art while providing numerous additional advantages and benefits not contemplated or possible with prior art constructions.

### SUMMARY OF THE INVENTION

A faucet lever safety lock is disclosed herein. The faucet lever safety lock is advantageous in that it secures a faucet to prevent unwanted or unauthorized operation of the faucet. This is beneficial to safety and security, and may be used to eliminate water waste indoors and outdoors. The faucet lever safety lock is also convenient to use and highly reliable.

The faucet lever safety lock may have a variety of configurations. For instance in one exemplary embodiment, a faucet lever safety lock may comprise a first handle engagement device configured to engage a first faucet handle, and a second handle engagement device configured to engage a second faucet handle.

A first strut having a proximal end and a distal end may support the first handle engagement device at its distal end. A coupling device may be between the first strut and the second handle engagement device to releasably attach the proximal end of the first strut to the second handle engagement device. For example, the coupling device may be a hollow tubular structure configured to accept the proximal end of the first strut therein. It is noted that a second strut having a proximal end and a distal end may be provided to support the second handle engagement device at its distal end. In such case, the coupling device may releasably attach the proximal end of the first strut to the proximal end of the second strut.

A locking mechanism configured to secure the first strut and the second handle engagement device until the locking mechanism is unlocked may be at the coupling device.

The first and second handle engagement devices may extend laterally from the proximal ends of the first and second struts to physically engage the first and second faucet handle. In addition, the first and second handle engagement devices may comprise an opening to engage the first and second faucet handle by accepting at least a portion of the first and second faucet handles therein. For example, the first and second handle engagement devices may have a “U” shape to position the opening of the first and second handle engagement device lateral from the proximal ends of the first and second struts.

In another exemplary embodiment, a faucet lever safety lock may comprise a first elongated strut having a proximal end and a distal end, a first handle engagement device extending laterally from the distal end of the first elongate strut, and a second handle engagement device configured to engage a second faucet handle.

The first handle engagement device may be configured to engage a first faucet handle. In addition, the first handle engagement device may comprise a channel having an opening. In this manner, the first handle engagement device may engage the first faucet handle by accepting at least a portion of the first faucet handle in the channel via the opening. The opening may be located lateral of the distal end of the first elongated strut. It is contemplated that the second handle engagement device may also comprise a channel having an opening. In this manner, the second handle engagement device may engage the second faucet handle by accepting at least a portion of the first faucet handle in the channel via the opening.

A coupling device may be configured to releasably connect the proximal end of the first elongated strut to the second handle engagement device. The coupling device may be configured to fit within an opening at the proximal end of the first elongated strut. It is noted that the coupling device may be integrally formed with the proximal end of the first elongated strut.

A second elongated strut having a proximal end and a distal end may be provided as well. The second handle engagement device may extend laterally from the second elongated strut at the distal end of the second elongated strut, such that the coupling device releasably connects the proximal ends of the second elongated strut and the first elongated strut.

Various methods of locking or otherwise controlling operation of a faucet are disclosed herein as well. For example, a method of controlling operation of a faucet with a faucet lever safety lock may comprise positioning a first handle engagement device adjacent a first faucet handle, and positioning a second handle engagement device adjacent a second faucet handle. It is noted that the first handle engagement device may extend laterally from a distal end of a first strut.

At least a portion of the first faucet handle may be inserted into the first handle engagement device via an opening in the first handle engagement device. Likewise, at least a portion of the second faucet handle may be inserted into the second handle engagement device via an opening in the second handle engagement device. A proximal end of the first strut may then be connected to the second handle engagement device with a coupling device to secure the first and second handle engagement devices at the first and second faucet handles. The coupling device may optionally be locked by inserting a locking pin into an opening of the coupling device. Alternatively or in addition, connecting the first strut to the second handle engagement device may include rotating the first strut relative to the coupling device, such as to thread the first strut onto one or more threads.

It is noted that the second handle engagement device may also extend laterally from a distal end of a second strut. In this manner, connecting the proximal end of the first strut to the second handle engagement device may be accomplished by connecting the proximal end of the first strut to a proximal end of the second strut.

The first strut and the second handle engagement device may be disconnected at the coupling device to allow the faucet to be used or operated once again.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1A is a perspective view and an exemplary faucet lever safety lock;

FIG. 1B is an exploded view of an exemplary faucet lever safety lock;

FIG. 1C is a partially assembled view of an exemplary faucet lever safety lock;

FIG. 1D is a perspective view of an exemplary faucet lever safety lock;

FIG. 2A is a perspective view of an exemplary faucet lever safety lock in operation;

FIG. 2B is a perspective view of an exemplary faucet lever safety lock in operation;

FIG. 3A is a perspective view of an exemplary coupling mechanism of the faucet lever safety lock;

FIG. 3B is a perspective view of an exemplary coupling mechanism of the faucet lever safety lock;

FIG. 3C is a perspective view of an exemplary coupling mechanism of the faucet lever safety lock;

FIG. 4A is a perspective view illustrating installation of an exemplary faucet lever safety lock; and

FIG. 4B is a perspective view illustrating installation of an exemplary faucet lever safety lock.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the faucet lever safety lock provides safety features for various faucets or other similar plumbing fixtures. The faucet lever safety lock is advantageous in that it prevents a faucet from being used when in a locked configuration. This prevents unauthorized used of the faucet, water waste, and prevents hazards from coming about due to unwanted water usage. For example, in the case of children, the faucet lever safety lock is beneficial in that it prevents children from turning on faucets, wasting water, and most importantly from hurting themselves, such as by scalding themselves or drowning in pooled water. Other benefits of the faucet lever safety lock include its ease of use and convenience and its ability to reliably lock a faucet such that the faucet's handles can no longer be operated.

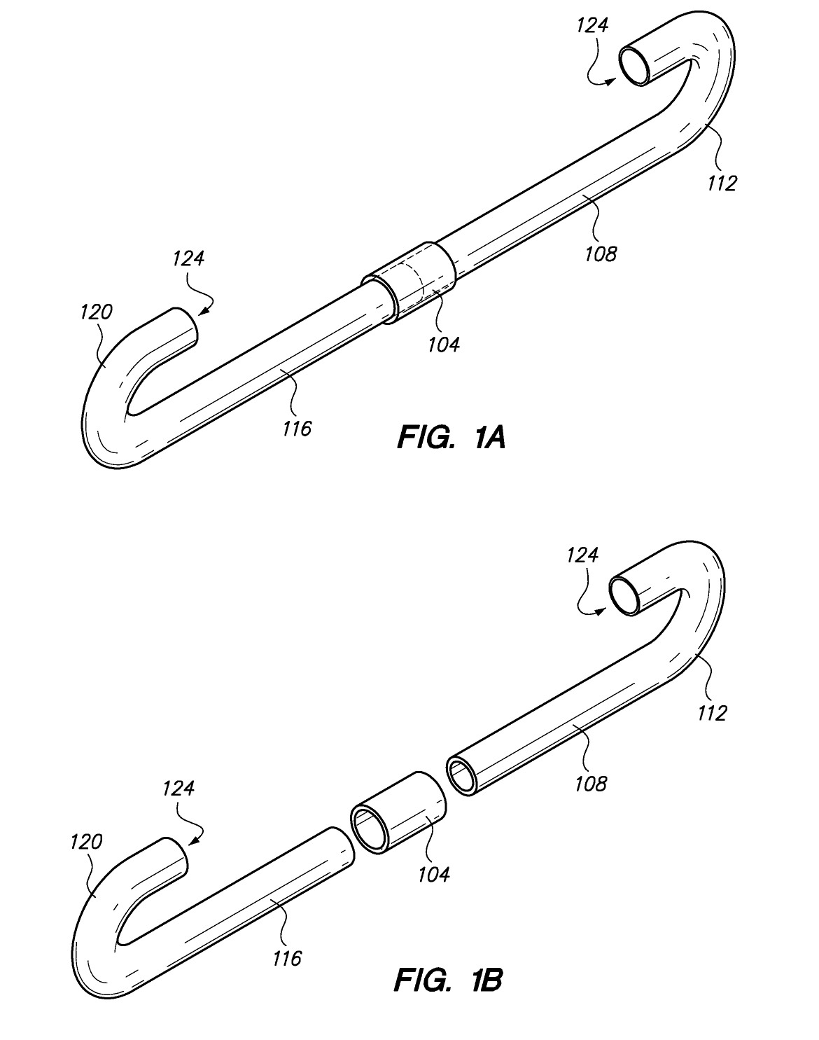

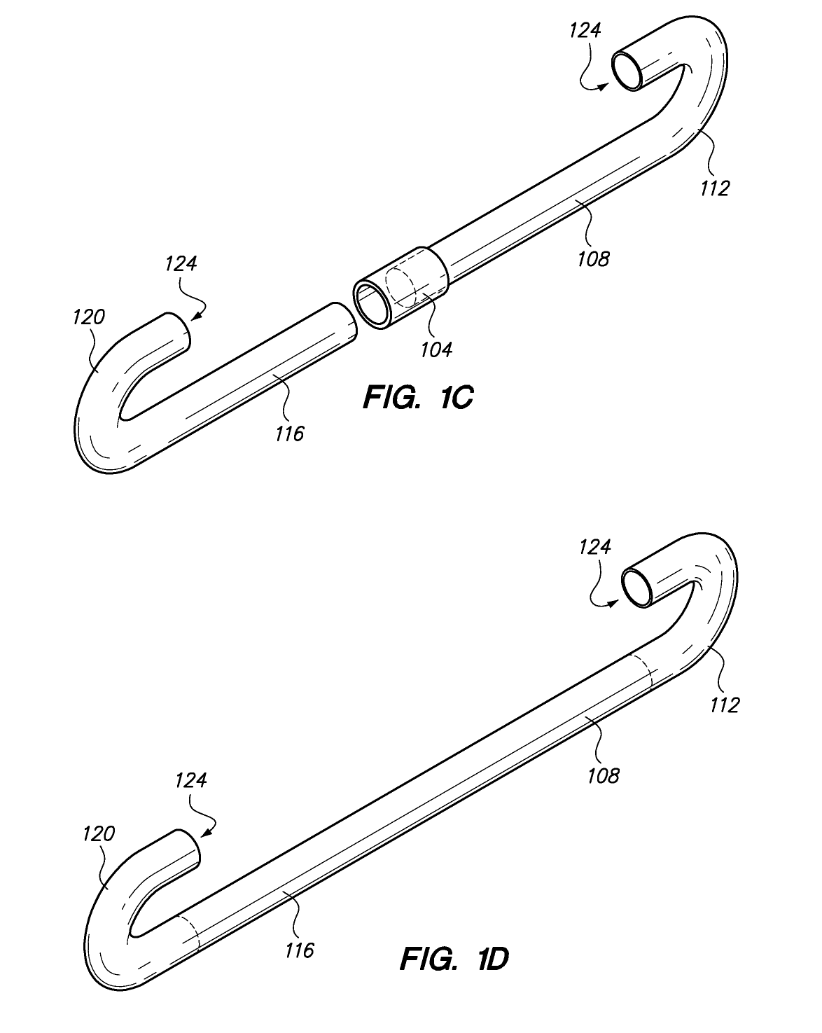

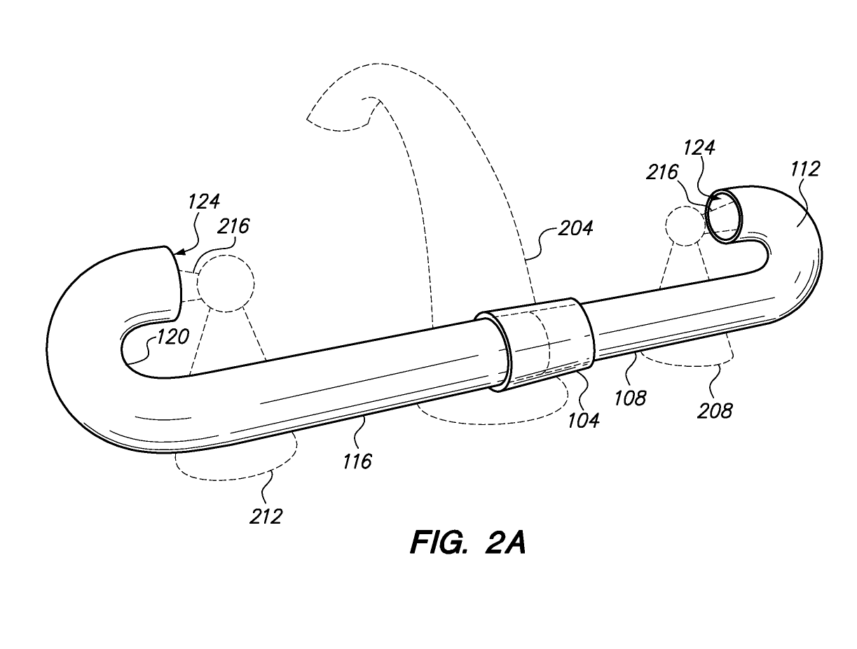

The faucet lever safety lock will now be described with regard to FIGS. 1A-1C. FIG. 1A illustrates an exemplary faucet lever safety lock in an assembled configuration. As can be seen, the faucet lever safety lock may have an elongated structure with two ends that are arranged to engage a faucet's handles. To illustrate, the faucet lever safety lock may comprise one or more struts 108,116 that extend to form the length of the faucet lever safety lock. The distal ends of the struts 108,116 may support handle engagement devices 112,120 that may be configured to engage a faucet's handles to lock them, as will be described further below.

The handle engagement devices 112,120 may have various configurations. In one or more embodiments, a handle engagement device 112,120 may provide a structure that physically contacts or engages a faucet handle to prevent its operation. This may occur by blocking physical contact/access to the faucet handle and/or physically blocking movement of the faucet handle.

In one or more embodiments, the handle engagement devices 112,120 may extend a distance outward at the distal ends of the struts 108,116. For instance, as shown the handle engagement devices 112,120 extend laterally outward at the distal ends of the struts 108,116 via a “U” shaped structure. This positions an opening 124 of the handle engagement devices 112,120 at a location that is lateral from the struts 108,116 allowing the handle engagement devices 112,120 to engage the handles of a faucet, as will be described below.

An opening 124 may be an opening to a channel, chamber, or the like of the handle engagement devices 112,120, which accepts at least a portion of a faucet handle when the faucet lever safety lock is installed. The channel or chamber may prevent physical access to the faucet handle and/or physically block movement of the faucet handle in this manner. It is noted that the handle engagement devices 112,120 may comprise various structures to support their openings 124 and/or channels/chambers other than that shown. For instance, the handle engagement devices 112,120 may be “I” shaped or be a block shape in some embodiments.

As can be seen in FIG. 1A, the handle engagement devices 112,120 each comprise an opening 124 to accept a portion of a faucet handle. The handle engagement devices 112,120 are shaped such that they bend inward towards a central portion of the faucet lever safety lock. In this manner, the openings 124 of the handle engagement devices 112,120 may face one another. The handle engagement devices 112,120 may have one or multiple bends to allow the openings 124 to be positioned at such location that they may engage handles of a variety of faucets. For example, as shown in the exemplary embodiment of FIG. 1A, the handle engagement devices 112,120 form a “U” shaped structure at the ends of the faucet lever safety lock so that the openings 124 of the handle engagement devices 112,120 face one another. In this manner, a faucet with outward facing handles may be engaged by the faucet lever safety lock, as will be described further below.

It is contemplated that the faucet lever safety lock may lock handles that face inwardly or in other directions as well. This is because the handle engagement devices 112,120 may comprise a variety of structures as disclosed above. For example, the handle engagement devices 112,120 may each have a channel having openings 124 on both of its ends (not shown). In this manner, a faucet handle may be inserted in either end. For example, a inward facing faucet handle may be inserted into a first end of a channel while an outward facing end may be inserted into a second end of the channel.

The faucet lever safety lock may be separable into multiple portions or sections. As such, in one or more embodiments, a coupling device 104 may be provided to releasably connect various portions of the faucet lever safety lock. As can be seen in FIG. 1A, the coupling device 104 may be centrally located. In general, the struts 108,116 may be connected to one another via the coupling device to form an assembled faucet lever safety lock.

FIG. 1B illustrates an exploded view of the faucet lever safety lock. As can be seen, the struts 108,116 have been disengaged or disconnected from the coupling device 104 in this drawing. This expands the distance between the openings 124 of the handle engagement devices 112,120 to allow them to be moved inward to engage a faucet's handles, as will be described further below. The struts 108,116 may be connected via the coupling mechanism 104 to form the assembled faucet lever safety lock, such as shown in FIG. 1A.

As shown, the coupling mechanism 104, is a tubular structure having a diameter larger than that of the struts 108,116. In this manner, the struts 108,116 may be inserted a distance into the coupling mechanism 104 to secure themselves to the coupling mechanism. The coupling mechanism 104 may hold the struts 108,116 by a friction fit or through various fasteners, locks, or connectors as will be described further below.

It is noted that only one of the struts 108,116 may be removable from the coupling device 104 in some embodiments. In other words, the coupling device 104 may be integrally formed into or with one of the struts 108,116. In this manner, one of the struts 108,116 will still be releasable from the other. This is shown in FIG. 1C.

As stated above, various portions of the faucet lever safety lock may be removable in one or more embodiments. FIG. 1D illustrates an embodiment where the handle engagement devices 112,120 are removable from the struts 108,116, such as at the broken lines. A coupling device may be present at the broken lines to allow the handle engagement devices 112,120 to be removably attached to the struts 108,116. It is contemplated that only one of the handle engagement devices 112,120 may be removable, while the other is permanently affixed to a strut 108,116. In addition, as can also be seen in FIG. 1D, the struts 108,116 may be non-detachable (i.e., be a single structure), such as in embodiments where at least one handle engagement device 112,120 is removable.

It is noted that in some embodiments, the faucet lever safety lock may have no removable elements. For example, it is contemplated that the struts 108,116 may telescope outward from one another thus extending the length of the faucet lever safety lock. In such an embodiment, one of the struts 108,116 may be received within tubular structure of the other strut. The struts 108,116 may then be retracted or moved inward to engage the handles of a faucet, such as described below. Once in a retracted position, the struts may be secured in position, such as via a set screw, pin, clamp, clip, or other fastener to lock the faucet handles.

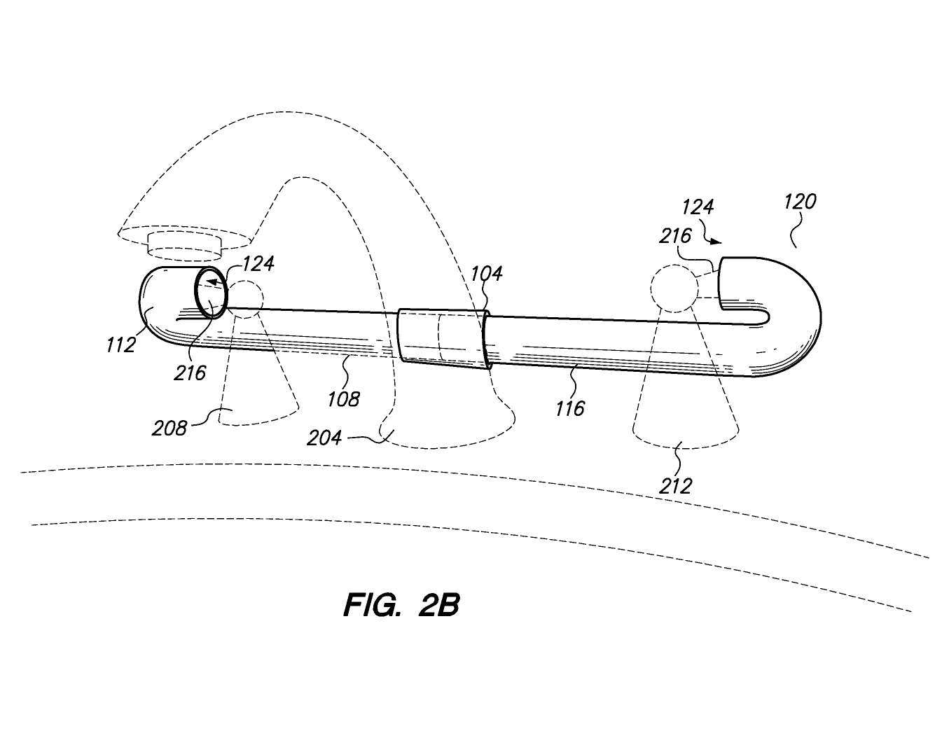

FIGS. 2A-2B illustrate an exemplary faucet lever safety lock in operation. FIGS. 2A and 2B respectively illustrate a rear and front perspective view of an exemplary faucet 204 locked with the faucet lever safety lock. As can be seen, the faucet 204 includes two handles 216 which are rotatably mounted to or via a base 208. The handles 216 may move (e.g., may be rotated) from a closed position to an open position to turn water flow off and on, respectively. Typically, the faucet lever safety lock, when installed, will hold the handles 216 in a closed position to prevent water flow from being turned on.

To illustrate, in FIGS. 2A-2B it can be seen that the faucet lever safety lock may be assembled or installed such that when its struts 108,116 are connected via the coupling device 104, the openings of the handle engagement devices 112,120 engage the handles 216 of the faucet 204. More specifically, the handles 216 are received in the openings 124 of the handle engagement devices 112,120 thereby preventing their movement. In this way, the handles 216 cannot be moved or rotated and the faucet 204 is thus locked. Even if one were to attempt rotating the handles 216 via an portion of the handles that is external to the openings 124, such rotation would be stopped by physical contact between the handles 216 and the openings 124. Likewise, if rotation of the handles 216 is attempted via the base 208, 212 of the handles, such rotation would also be blocked via the handle engagement devices 120,112.

It is contemplated that the openings 124 of the handle engagement devices 112,120 or the devices themselves may be larger or smaller than shown to accommodate handles 216 of various shapes and sizes. In addition, it is contemplated that the openings 124 may be configured to conform to the shape of a handle 216 to better secure the handle. For example, an opening 124 may be share the outer peripheral shape and/or size of a handle 216 to conform snugly thereto. In this manner, any or all rotation of the handle 216 may be prevented once the handle 216 is positioned within the opening.

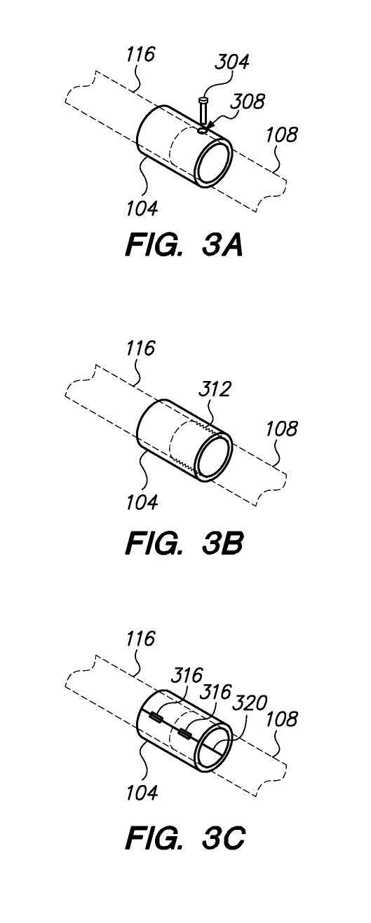

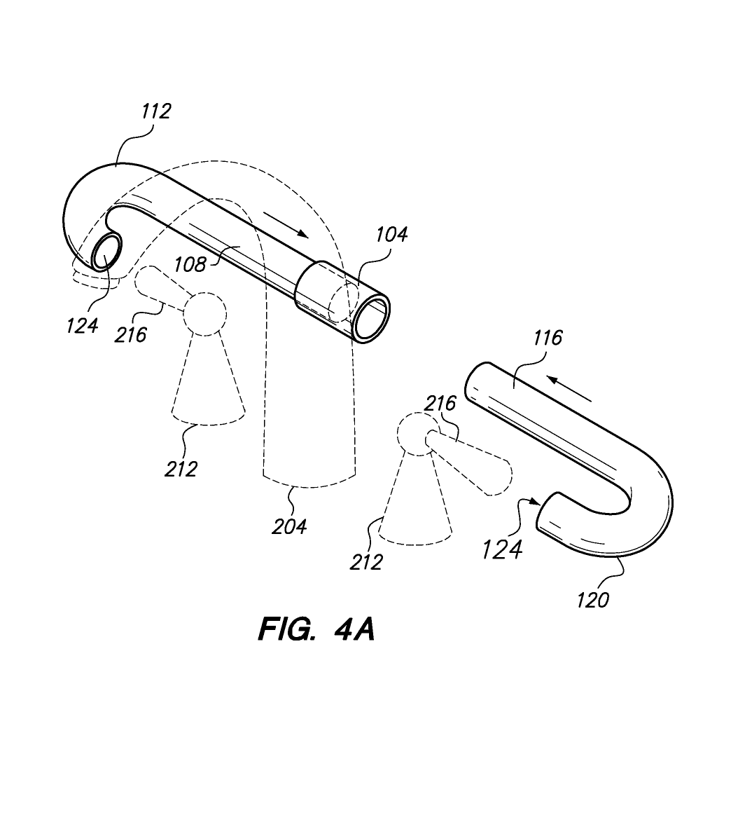

As described above with regard to FIGS. 1A-1C, the coupling device 104 may have various configurations. As stated, the coupling device 104 may be used to secure the struts 108,116 of the faucet lever safety lock together to install the faucet lever safety lock to lock a faucet. The coupling device 104 may secure the struts 108,116 via a friction fit or through various connectors, fasteners or other structures as will now be described with reference to FIGS. 3A-3C.

FIG. 3A illustrates a coupling device 104 that includes a locking pin 304 which helps prevent a strut 108 from becoming disconnected from the coupling device. For example, the locking pin 304 may be inserted into an opening in the coupling device 104 and pressed against an outer surface of the strut 108 to secure the strut in place. In such an embodiment, the locking pin 304 may be threaded (e.g., be a screw or other threaded fastener) so that it may be rotated to apply pressure to the outer surface of the strut 108. Alternatively, the locking pin 304 may be inserted into an opening in the coupling device 104 and an opening in the strut 108 to secure the strut. Though shown as securing a single strut 108 with a single locking pin 304, it is noted that both struts 108,116 may be secured with one or more locking pins 304.

It is contemplated that in a threaded embodiment, the head or end of the locking pin 304 may have a particular depression requiring a particular tool to turn the locking pin. For example, the locking pin 304 may have a slotted head or a Philips head like that of a screw. Alternatively, the locking pin 304 may have a head having a uniquely shaped depression, such as a polygonal shape with or without one or more curves. In this manner, the faucet lever safety lock may only be removed by a user having the properly shaped tool that matches the depression of the locking pin 304. This prevents unauthorized removal of the faucet lever safety lock.

FIG. 3B illustrates a coupling device 104 having one or more threads 312 on an inner surface therein. In such an embodiment, the outer surface of a strut 108 may have one or more threads at its proximal end. In this manner, the strut 108 may be rotated engaging the threads 312 of the coupling device 104 to secure the strut 108 to the coupling device. Though shown as securing a single strut 108, it is noted that both struts 108,116 may be secured in this manner. For example, both ends of the coupling device 104 may have threads 312 and both struts 108 may have matching threads at their proximal ends.

FIG. 3C illustrates a coupling device 104 utilizing a clasping mechanism to secure the struts 108,116 to one another. As can be seen the clasping mechanism may utilize one or more hinges or pivots 316. In this manner, a first and second portion of the coupling device 104 may rotate relative to one another such as to open or close. To secure the struts 108,116, the portions may be opened and then closed around a proximal end of the struts. The struts 108,116 may have raised or depressed portions that engage corresponding portions of an interior surface of the coupling device 104 to secure the struts therein. This prevents the struts 108,116 from pulling out of the coupling device 104 unless the coupling device is first opened. It is noted that the coupling device 104 may have one or more latches to prevent it from opening when not desired. In one or more embodiments, the latch may be lockable such as with a key or combination lock. This provides additional security since it would prevent use of a faucet unless the user has the proper code or key. In other situations, such as those involving toddlers or children, the use of the faucet lever safety lock by itself can prevent use of the faucet.

The coupling device 104 may be constructed from various materials, such as plastic, metal, rubber, synthetic materials, or even wood. For example, a coupling device 104 could be a rigid or semi-rigid rubber boot, which may connect the arms 108,116 as described above.

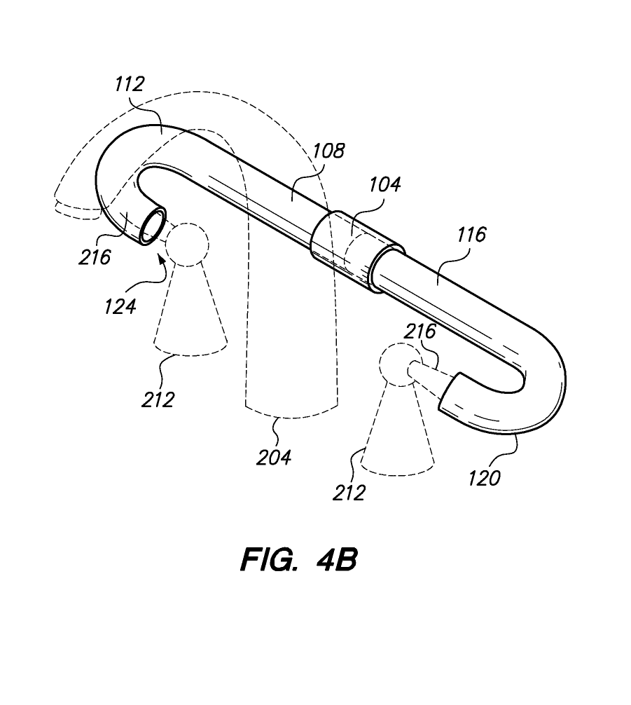

FIGS. 4A-4B illustrate installation of an exemplary faucet lever safety lock. FIG. 4A illustrates a faucet 204 having its handles 216 in a closed position thus preventing water flow. As can be seen from FIG. 4A, the faucet lever safety lock may be disassembled, such as at its coupling device 104 so that it may be expanded. The faucet lever safety lock may then be assembled by bringing its struts 108,116 together (in the direction shown by the arrows of FIG. 4A) and coupling or attaching them at the coupling device 104, such as shown in FIG. 4B. Once assembled it can be seen that the handles 216 of the faucet 204 no longer can be accessed to turn on the faucet. To illustrate, in FIG. 4B, the handles 216 enter the openings 124 of the faucet lever safety lock and thereby can no longer be rotated. This locks the faucet preventing unauthorized or unwanted operation.

As can be seen in FIG. 4B once assembled or installed, the faucet lever safety lock cannot be removed from the handles 216 of a faucet 204 unless it is first disassembled. This is advantageous in that it provides the locking described above by obstructing access to the handles 216 and thus prevents operation of the faucet 204. Various levels of locking may be provided to prevent users of various types from circumventing the faucet lever safety lock. For example, for more sophisticated users such as adults, the coupling device 104 of the faucet lever safety lock may require specialized tools, a key, a code, or the like to release a strut 108,116 from the coupling device. For less sophisticated users, such as children for example, simply assembling or installing the faucet lever safety lock on the handles 216 of a faucet 204 may be sufficient.

In any case, the faucet lever safety lock will typically have to be disassembled before a locked faucet 204 will be operational again, as can be seen from FIG. 4B. As can be seen, the assembled faucet lever safety lock of FIG. 4B has engaged a portion of the handles 216 by accepting the handles into its handle engagement devices 112,120. The handle engagement devices 112,120 prevent physical contact with and access to the handles 216 in this manner. In addition, the engagement of the handle engagement devices 112,120 and handles 216 prevent the faucet lever safety lock from being removed. In FIG. 4B for instance, this engagement prevents the handle engagement devices 112,120 from being moved forward, backward, up, or down, relative to the handles 216.

The coupling device 104 and struts 108,116 prevent the handles engagement devices 112,120 from being moved inward or outward. This prevents the assembled faucet lever safety lock from being removed without first being disassembled. The faucet is thus locked.

It is noted that, depending on the coupling device 104, the faucet lever safety lock may be installed or assembled in various ways. For example, in one embodiment, the coupling device 104 may utilize a friction fit and thus the struts 108,116 of the faucet lever safety lock may simply be inserted into the coupling device to assembled the faucet lever safety lock. It is noted that the coupling device 104 may have a smaller diameter than the struts 108,116 in some embodiments. In such embodiments, the coupling device 104 may be inserted into a proximal end of one or both struts 108,116 to assemble the faucet lever safety lock.

One or more pins or other fasteners, such as screws, may be inserted to prevent the struts 108,116 from releasing from the coupling device 104, such as described above.

In an embodiment where the coupling device 104 is threaded, it is contemplated that the coupling device 104 may be rotated to engage the threads of a proximal end of one or both struts 108,116. It is noted that there may be a number of threads extending along the inner circumference of the coupling device 104 multiple times. In some embodiments, the threads may only extend one rotation or less than one rotation around the circumference of the coupling device 104. Rather than a thread, it is contemplated that the struts 108,116 could alternatively have a outward extending pin or the like which engage the thread of the coupling device 104 when the faucet lever safety lock is assembled. It is noted that the pin may be one the coupling device 104, while the threads are on a proximal end of one or both struts 108,116.

In an embodiment, where the coupling device 104 is a clasp, such clasp may be closed around a proximal end of one or both struts to secure the strut. It is noted that the foregoing coupling devices 104 have been described as securing a proximal end of one or both struts 108,116. This is because, as discussed above, the coupling device 104 may be formed integral with one of the struts 108,116. In such embodiment, the coupling device 104 would only need to secure one strut 108,116 since it would be integrally formed with the other strut.

When use of the faucet is desired, the faucet lever safety lock may be disassembled, such that its two portions are separated. In general, this involves releasing the coupling or attachment between the coupling device 104 and at least one of the struts 108,116. The faucet lever safety lock's two sections can then be disengaged from the handles 216, such as shown in FIG. 4A. For example, the handles 216 may be removed from the openings 124 of the faucet lever safety lock to allow them to move freely and be freely accessed once again. The user may then operate the faucet 204 normally.

As can be seen, the faucet lever safety lock provides a convenient locking apparatus for faucets 204 to prevent water waste and potential drowning hazards, especially for younger children.

Though shown in use with a particular faucet it is contemplated that the faucet lever safety lock may be used with a variety of handles 216. For example, handles 216 having more than one spoke could be locked with the faucet lever safety lock. This is because the faucet lever safety lock need only engage one spoke of a handle 216 to lock that handle. For example, a single spoke could be inserted in the opening 124 of the faucet lever safety lock to lock the handle 216 in position.

It is contemplated that various faucets may be locked with the faucet lever safety lock. For example, bathtub, sink, and utility faucets may be locked with the faucet lever safety lock. One or more struts of the faucet lever safety lock may be elongated to accommodate faucets with handles that are spaced further apart, such as a bathtub (versus a sink). It is noted that one or more of the struts may be extendable so as to accommodate a variety of distances between faucet handles. For example, a strut may comprise a first tubular section from which a second section may extend. In one or more embodiments, the strut may be fixed or secured at a desired length such as via one or more pins/detents, twist-lock mechanisms, and the like. In other embodiments, it is contemplated that a strut may be disconnected from the coupling device and replaced with another of a different length to lock a faucet having a different handle spacing.

Typically, the faucet lever safety lock will be formed from rigid or semi-rigid materials to prevent the faucet lever safety lock from being removed by bending one or more portions of the faucet lever safety lock to release one or more handles of a faucet.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A faucet lever safety lock comprising:
a first handle engagement device configured to engage a first faucet handle;
a second handle engagement device configured to engage a second faucet handle;
a first strut having a proximal end and a distal end, the first handle engagement device at the distal end; and
a coupling device between the first strut and the second handle engagement device, the coupling device configured to releasably attach the proximal end of the first strut to the second handle engagement device.

2. The faucet lever safety lock of claim 1 further comprising a second strut having a proximal end and a distal end, the second handle engagement device at the distal end, wherein the coupling device releasably attaches the proximal end of the first strut to the proximal end of the second strut.

3. The faucet lever safety lock of claim 1 wherein the coupling device is a hollow tubular structure configured to accept the proximal end of the first strut therein.

4. The faucet lever safety lock of claim 1 wherein the first and second handle engagement device extend laterally from the proximal ends of the first and second struts to physically engage the first and second faucet handle.

5. The faucet lever safety lock of claim 1 wherein the first and second handle engagement devices comprise an opening to engage the first and second faucet handle by accepting at least a portion of the first and second faucet handles therein.

6. The faucet lever safety lock of claim 5 wherein the first and second handle engagement devices have a “U” shape to position the opening of the first and second handle engagement device lateral from the proximal ends of the first and second struts.

7. The faucet lever safety lock of claim 1 further comprising a locking mechanism at the coupling device, the locking mechanism configured to secure the first strut and the second handle engagement device until the locking mechanism is unlocked.

8. A faucet lever safety lock comprising:
a first elongated strut having a proximal end and a distal end;
a first handle engagement device extending laterally from the distal end of the first elongate strut, the first handle engagement device configured to engage a first faucet handle;
a second handle engagement device configured to engage a second faucet handle; and
a coupling device configured to releasably connect the proximal end of the first elongated strut to the second handle engagement device.

9. The faucet lever safety lock of claim 8 wherein the coupling device is configured to fit within an opening at the proximal end of the first elongated strut.

10. The faucet lever safety lock of claim 8 wherein the first handle engagement device comprises a channel having an opening, the first handle engagement device configured to engage the first faucet handle by accepting at least a portion of the first faucet handle in the channel via the opening.

11. The faucet lever safety lock of claim 10 wherein the opening is located lateral of the distal end of the first elongated strut.

12. The faucet lever safety lock of claim 10 wherein the second handle engagement device comprises a channel having an opening, the second handle engagement device configured to engage the second faucet handle by accepting at least a portion of the first faucet handle in the channel via the opening.

13. The faucet lever safety lock of claim 8 further comprising a second elongated strut having a proximal end and a distal end, the second handle engagement device extending laterally from the second elongated strut at the distal end of the second elongated strut, wherein the coupling device releasably connects the proximal ends of the second elongated strut and the first elongated strut.

14. The faucet lever safety lock of claim 8 wherein the coupling device is integrally formed with the proximal end of the first elongated strut.

15. A method of controlling operation of a faucet with a faucet lever safety lock comprising:
positioning a first handle engagement device adjacent a first faucet handle, the first handle engagement device extending laterally from a distal end of a first strut;
positioning a second handle engagement device adjacent a second faucet handle;
inserting at least a portion of the first faucet handle into the first handle engagement device via an opening in the first handle engagement device;
inserting at least a portion of the second faucet handle into the second handle engagement device via an opening in the second handle engagement device; and
connecting a proximal end of the first strut to the second handle engagement device with a coupling device to secure the first and second handle engagement devices at the first and second faucet handles.

16. The method of claim 15 wherein the second handle engagement device extends laterally from a distal end of a second strut and wherein connecting the proximal end of the first strut to the second handle engagement device comprises connecting the proximal end of the first strut to a proximal end of the second strut.

17. The method of claim 15 further comprising locking the coupling device by inserting a locking pin into an opening of the coupling device.

18. The method of claim 15 wherein connecting the first strut to the second handle engagement device comprises rotating the first strut relative to the coupling device.

19. The method of claim 15 further comprising preventing operation of the first and second faucet handle by surrounding the first and second faucet handle with the first and second handle engagement devices.

20. The method of claim 15 further comprising disconnecting the first strut and the second handle engagement device at the coupling device.
